(19) United States
(12) Patent Application Publication
(10) Pub. No.: US 2010/0014003 A1
(43) Pub. Date: Jan. 21, 2010

(54) MOBILE MEDIA DEVICE AND METHOD FOR PLAYING MEDIA STREAM

(76) Inventor: Yao-Tsung CHANG, Taipei Hsien (TW)

Correspondence Address: Muncy, Geissler, Olds & Lowe, PLLC, P.O. BOX 1364, FAIRFAX, VA, 22038-1364, US

(21) Appl. No.: 12/398,694

(22) Filed: Mar. 5, 2009

(30) Foreign Application Priority Data
Jul. 18, 2008 (TW) 97127436

(51) Int. Cl. H04N 5/50; H04B 1/18; H04L 27/06

(52) U.S. Cl. 348/731; 455/179.1; 375/344; 348/E05.097

(57) ABSTRACT

A mobile media device is disclosed. The mobile media device includes a database, a list-selecting unit, a channel-selecting unit, a tuning unit and a playing unit. The database stores several data channel lists, wherein each of the data channel lists has a location information column. The list-selecting unit selects a local channel list from the data channel lists by comparing present location information of the mobile media device with the location information columns of the data channel lists. The channel-selecting unit selects information of a channel from the local channel list. The tuning unit obtains a media stream according to the information of the channel. The playing unit plays the media stream.

### RELATED APPLICATIONS

This application claims priority to Taiwan Application Serial Number 97127436, filed Jul. 18, 2008, which is herein incorporated by reference.

### BACKGROUND

1. Field of Invention

The present invention relates to a mobile device. More particularly, the present invention relates to a mobile media device.

2. Description of Related Art

As digital broadcasting players become smaller, users may use digital broadcasting players as mobile media devices. Since channel frequencies differ at different places, digital broadcasting players may need to scan digital broadcasting frequencies before being played at a different location, which may disturb users. In addition, users may move between several fixed places. Therefore, when the users moves to one of these fixed places, it wastes time to wait for the digital broadcasting players to scan again.

### SUMMARY

According to one embodiment of this invention, a mobile media device is provided. The mobile media device includes a database, a list-selecting unit, a channel-selecting unit, a tuning unit and a playing unit. The database stores several data channel lists, wherein each of the data channel lists has a location information column. The list-selecting unit selects a local channel list from the data channel lists by comparing present location information of the mobile media device with the location information columns of the data channel lists. The channel-selecting unit selects information of a channel from the local channel list. The tuning unit obtains a media stream according to the information of the channel. The playing unit plays the media stream.

According to another embodiment of this invention, the method for playing a media stream is provided. The method for playing the media stream includes following steps:
(a) Obtain present location information.
(b) Select a local channel list from a database according to the present location information.
(c) Select information of a channel from the local channel list.
(d) Obtain a media stream according to the information of the channel.
(e) Play the media stream.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a block diagram of a mobile media device 100 according to an embodiment of this invention;

FIG. 2 is an embodiment of the playing module 101 in FIG. 1;

FIG. 3 is an embodiment of the scanning module 102 in FIG. 1;

FIG. 4 is a flow diagram of a method for playing a media stream according to an embodiment of this invention;

FIG. 5 is an embodiment of obtaining the present location information (step 302) in FIG. 4;

FIG. 6 is another embodiment of obtaining the present location information (step 302) in FIG. 4;

FIG. 7 is an embodiment of obtaining the local channel list by scanning in the method for playing the media stream; and

FIG. 8 is another embodiment of obtaining the local channel list by scanning in the method for playing the media stream.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

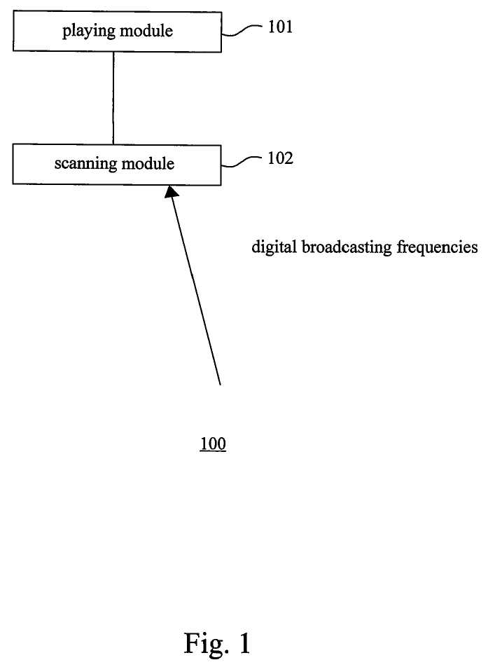

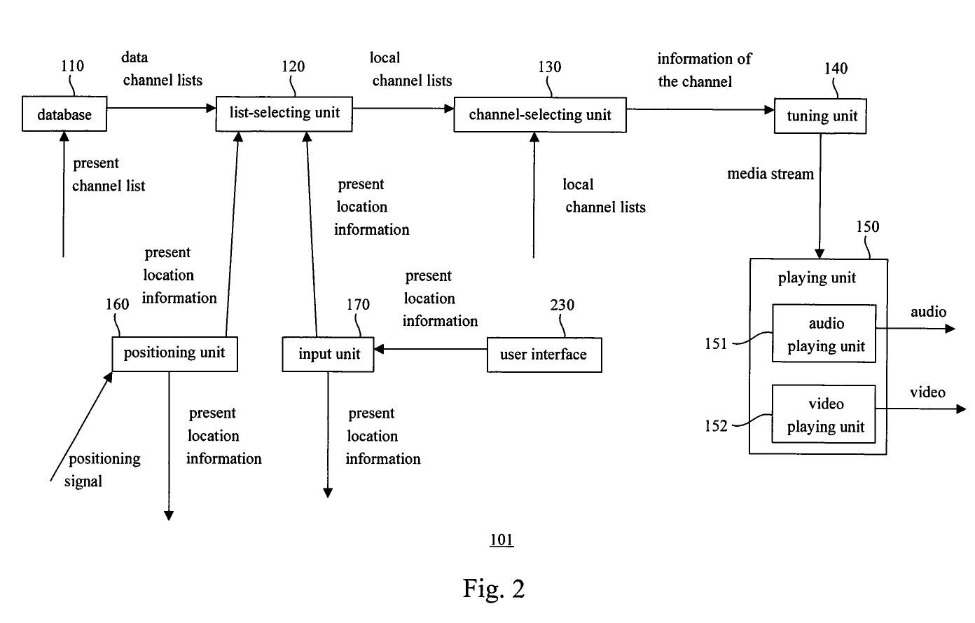

FIG. 1 is a block diagram of a mobile media device 100 according to an embodiment of this invention. The mobile media device 100 plays a media stream according to channel information stored in the database before. The mobile media device 100 includes a playing module 101 for playing a media stream. FIG. 2 is an embodiment of the playing module 101 in FIG. 1. The playing module 101 includes a database 110, a list-selecting unit 120, a channel-selecting unit 130, a tuning unit 140 and a playing unit 150. The database 110 stores several data channel lists. Each data channel list has a location information column, in which the location corresponding to the data channel list may be filled. The list-selecting unit 120 selects a local channel list from the data channel lists. In detail, the list-selecting unit 120 compares location information of the mobile media device 100 with the location information columns of the data channel lists, and selects one of the data channel lists, whose location information column is the same as the location information of the mobile media device 100, as the local channel list. Therefore, the list-selecting unit 120 can obtain the local channel list corresponding to the present location without scanning digital broadcasting frequencies. The channel-selecting unit 130 selects information of a channel from the local channel list. The information of the channel may include channel name, program menu, channel frequency, classification of the channel, or any other information about the channel. Therefore, users can utilize the information of the channels to select the channel they want to watch or listen. The tuning unit 140 obtains a media stream according to the information of the channel. The playing unit 150 plays the media stream. Above all, the mobile media device 100 can play the media stream according to the data channel lists stored in the database 110 without scanning the digital broadcasting frequencies.

The mobile media device 100 can obtain the location information of the mobile media device 100 by several ways. In FIG. 2, the mobile media device 100 may include a positioning unit 160. The positioning unit 160 positions the mobile media device 100 according to a positioning signal to obtain the location information of the mobile media device. The positioning signal may be signal of Global Positioning System (GPS), Assisted Global Positioning System (AGPS) or any other positioning methods.

In addition, the location information of the mobile media device 100 may be input by users through a user interface. Therefore, the mobile media device 100 may include an input unit 170 and a user interface 230. The input unit 170 obtains the present location information of the mobile media device 100 input from the user interface. Therefore, users can input the present location information of the mobile media device 100 through the user interface 230.

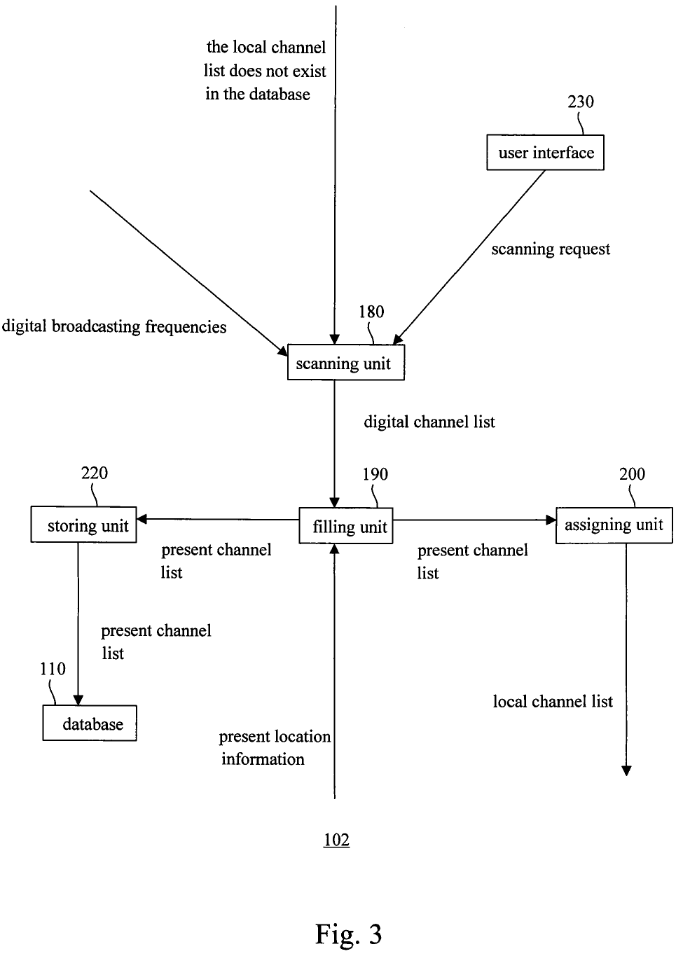

Referring to FIG. 1, when no data in the channel list corresponds to the present location information of the mobile media device 100 stored in the database 110, the mobile media device 100 may need a scanning module 102 to scan digital broadcasting frequencies to obtain a digital channel list. FIG. 3 is an embodiment of the scanning module 102 in FIG. 1. The scanning module 102 may include a scanning unit 180, a filling unit 190 and an assigning unit 200. The scanning unit 180 scans digital broadcast frequencies to obtain a digital channel list. The filling unit fills the present location information of the mobile media device 100 in a location information column of the digital channel list to generate a present channel list. The assigning unit 200 assigns the present channel list to be the local channel list. The scanning unit 180 is triggered once the local channel list does not exist in the database 110. Therefore, if there is no data channel list corresponding to the present location information of the mobile media device 100, the mobile media device 100 can obtain the local channel list by triggering the scanning unit 180.

In addition, the mobile media device 100 may store channel list obtained by scanning. In FIG. 3, the scanning module 102 may include a storing unit 220 for storing the present channel list to the database 110.

Furthermore, the mobile media device 100 can re-scan the digital broadcasting frequencies as users wish, even if the local channel list already exists in the database 110. In detail, the scanning unit 180 can be triggered once a scanning request is input through the user interface 230. In other words, users can make the scanning unit 180 re-scan by inputting the scanning request through the user interface 230.

The mobile media device 100 can play different types of media streams. In FIG. 2, the playing module 101 may include an audio playing unit 151 for playing audio of the media stream. Therefore, the mobile media device 100 can be applied for playing audio of media streams of Digital Audio Broadcasting (DAB), Digital Video Broadcasting (DVB) or any other digital broadcasting methods with audio media stream.

In addition, the playing module 101 may include a video playing unit 152 for playing video of the media stream. Therefore, the mobile media device 100 can be applied for playing the video of media streams of DVB or any other digital broadcasting methods with video media stream.

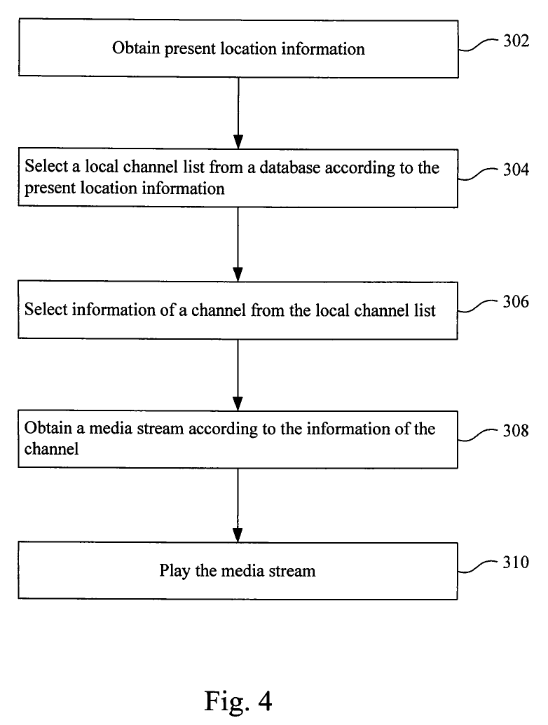

FIG. 4 is a flow diagram of a method for playing a media stream according to an embodiment of this invention. The method for playing the media stream utilizes channel information stored in the database before to play the media stream. The method for playing the media stream includes following steps:
(a) Obtain present location information (step 302).
(b) Select a local channel list from a database according to the present location information (step 304).
(c) Select information of a channel from the local channel list (step 306).
(d) Obtain a media stream according to the information of the channel (step 308).
(e) Play the media stream (step 310).

The information of the channel may include channel name, program menu, channel frequency, classification of the channel, or any other information about the channel. The media stream can be played without scanning digital broadcasting frequencies in advance.

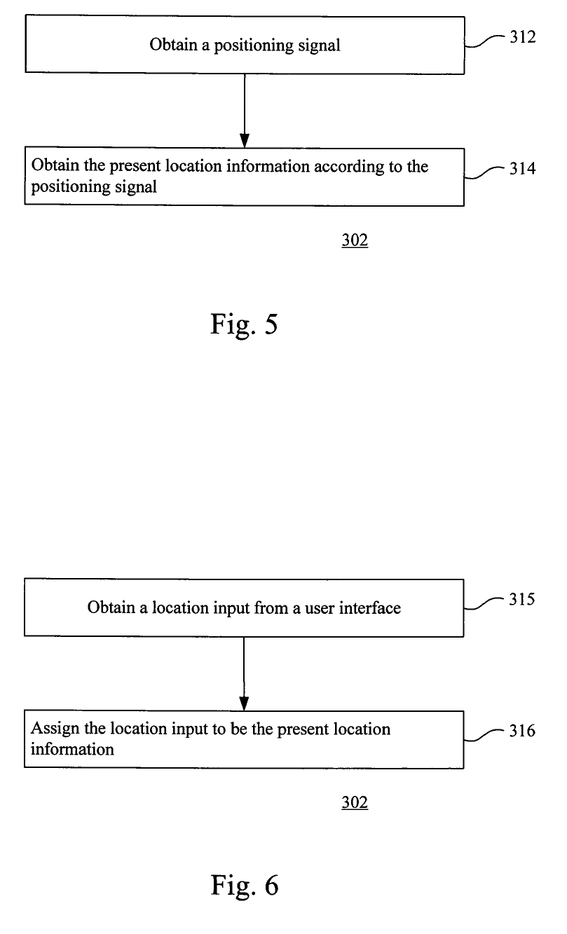

In addition, there are several ways to obtain the present location information (step 302). FIG. 5 is an embodiment of obtaining the present location information (step 302) in FIG. 4. Obtaining the present location information (step 302) may include following steps:
(f) Obtain a positioning signal (step 312).
(g) Obtain the present location information according to the positioning signal (step 314).

The positioning signal may be the signal of Global Positioning System (GPS), Assisted Global Positioning System (AGPS) or any other positioning method. Therefore, the present location information can be obtained according to the positioning signal.

FIG. 6 is another embodiment of obtaining the present location information (step 302) in FIG. 4. Obtaining the present location information (step 302) may include following steps:
(h) Obtain a location input from a user interface (step 315).
(i) Assign the location input to be the present location information (step 316).

Therefore, users can input the present location information through the user interface.

There are several ways to play the media stream (step 310). In detail, the method for playing the media stream may play audio of the media stream of the digital broadcasting, such as DAB, DVB or any other digital broadcasting method. In addition, the method for playing the media stream may play video of the media stream of the digital broadcasting, such as DVB or any other digital broadcasting method.

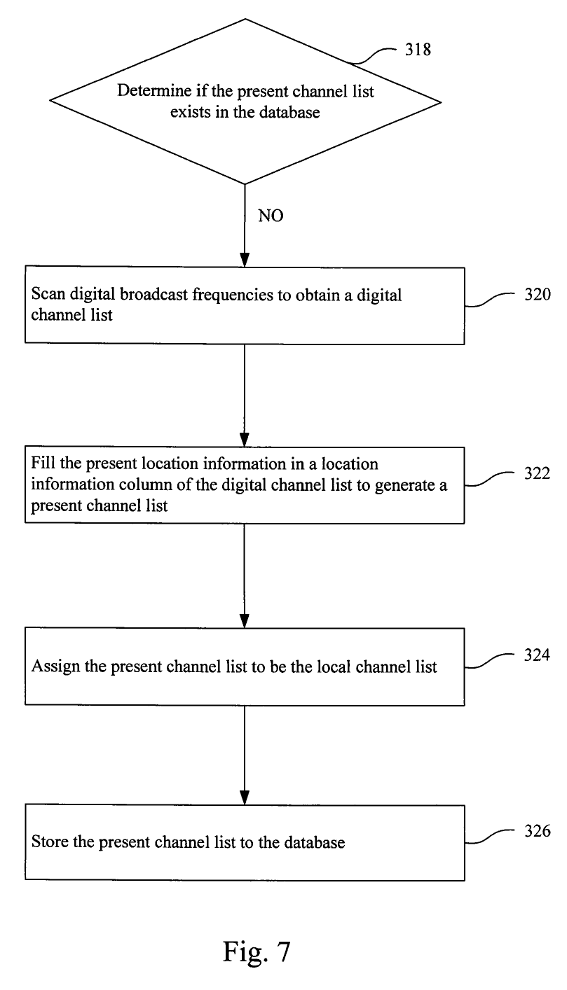

When the local channel list does not exist in the database, the local channel list can be obtained by scanning. FIG. 7 is an embodiment of obtaining the local channel list by scanning in the method for playing the media stream. Obtaining the local list by scanning includes following steps:
(j) Determine if the present channel list exists in the database (step 318).
(k) When the present channel list does not exist in the database, scan digital broadcast frequencies to obtain a digital channel list (step 320).
(l) Fill the present location information in a location information column of the digital channel list to generate a present channel list (step 322).
(m) Assign the present channel list to be the local channel list (step 324).

Therefore, when the local channel list does not exist in the database, the local channel list can still be obtained by scanning.

In addition, for making the present channel list, obtained by scanning, reusable, the method for playing the media stream may include following steps:
(n) Store the present channel list to the database (step 326).

Therefore, the present channel list obtained by scanning can be re-utilized when users want to watch or listen a media stream of digital broadcasting at the same place.

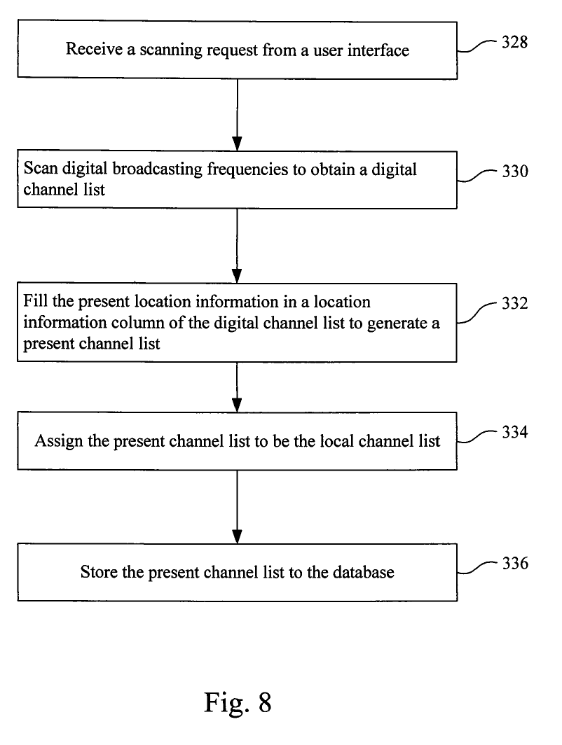

Furthermore, users can trigger re-scanning the digital broadcasting frequencies through the user interface. FIG. 8 is another embodiment of obtaining the local channel list by scanning in the method for playing the media stream. Obtaining the local list by scanning includes following steps:
(o) Receive a scanning request from a user interface (step 328).
(p) Once the scanning request is received, scan digital broadcasting frequencies to obtain a digital channel list (step 330).
(q) Fill the present location information in a location information column of the digital channel list to generate a present channel list (step 332).
(r) Assign the present channel list to be the local channel list (step 334).

Therefore, the present channel list can be obtained through the user interface, after users trigger re-scanning.

In addition, after the present channel list is obtained, the method for playing the media stream may include following steps:
(s) Store the present channel list to the database (step 336).

Therefore, the present channel list obtained by scanning can be re-utilized when users want to watch or listen a media stream of digital broadcasting at the same place.

Although the present invention has been described in considerable detail with reference to certain embodiments thereof, other embodiments are possible. Therefore, their spirit and scope of the appended claims should not be limited to the description of the embodiments contained herein. It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A mobile media device, comprising:
a database for storing a plurality of data channel lists, wherein each of the data channel lists has a location information column
a list-selecting unit for selecting a local channel list from the data channel lists by comparing present location information of the mobile media device with the location information columns of the data channel lists;
a channel-selecting unit for selecting information of a channel from the local channel list;
a tuning unit for obtaining a media stream according to the information of the channel; and
a playing unit for playing the media stream.

2. The mobile media device of claim 1, further comprising:
a positioning unit for positioning the mobile media device according to a positioning signal to obtain the present location information of the mobile media device.

3. The mobile media device of claim 1, further comprising:
a user interface; and
an input unit for obtaining the present location information of the mobile media device input from the user interface.

4. The mobile media device of claim 1, further comprising:
a scanning unit for scanning digital broadcast frequencies to obtain a digital channel list, wherein the scanning unit is triggered once the local channel list does not exist in the database;
a filling unit for filling the present location information of the mobile media device in a location information column of the digital channel list to generate a present channel list; and
an assigning unit for assigning the present channel list to be the local channel list.

5. The mobile media device of claim 4, further comprising:
a storing unit for storing the present channel list to the database.

6. The mobile media device of claim 4, further comprising:
a user interface, wherein the scanning unit is triggered once a scanning request is input through the user interface.

7. The mobile media device of claim 1, wherein the playing unit comprises:
an audio playing unit for playing audio of the media stream.

8. The mobile media device of claim 1, wherein the playing unit comprises:
a video playing unit for playing video of the media stream.

9. A method for playing a media stream, comprising:
obtaining present location information;
selecting a local channel list from a database according to the present location information;
selecting information of a channel from the local channel list;
obtaining the media stream according to the information of the channel; and
playing the media stream.

10. The method for playing the media stream of claim 9, wherein the step of obtaining the present location information comprises:
obtaining a positioning signal; and
obtaining the present location information according to the positioning signal.

11. The method for playing the media stream of claim 9, wherein the step of obtaining the present location information comprises:
obtaining location information input from a user interface; and
assigning the location information input to be the present location information.

12. The method for playing the media stream of claim 9, further comprising:
determining if the present channel list exists in the database;
when the present channel list does not exist in the database, scanning digital broadcast frequencies to obtain a digital channel list;
filling the present location information in a location information column of the digital channel list to generate a present channel list; and
assigning the present channel list to be the local channel list.

13. The method for playing the media stream of claim 12, further comprising:
storing the present channel list to the database.

14. The method for playing the media stream of claim 9, further comprising:
receiving a scanning request from a user interface;
scanning digital broadcasting frequencies to obtain a digital channel list once the scanning request is received;
filling the present location information in a location information column of the digital channel list to generate a present channel list; and
assigning the present channel list to be the local channel list.

15. The method for playing the media stream of claim 14, further comprising:
storing the present channel list to the database.

16. The method for playing the media stream of claim 9, wherein the step of playing the media stream comprises:
playing audio of the media stream.

17. The method for playing the media stream of claim 9, wherein the step of playing the media stream comprises:
playing video of the media stream.
